(19) United States
(12) Patent Application Publication
(10) Pub. No.: US 2019/0309645 A1
(43) Pub. Date: Oct. 10, 2019

(54) SYSTEMS AND METHODS FOR ELECTRICAL POWER GENERATION HAVING RECLAIMED ROTATIONAL ENERGY

(71) Applicant: Elysium Solutions LLC, Buckeye, AZ (US)

(72) Inventor: Ryan M. Doherty, Buckeye, AZ (US)

(73) Assignee: Elysium Solutions LLC, Buckeye, AZ (US)

(21) Appl. No.: 15/949,388

(22) Filed: Apr. 10, 2018

(51) Int. Cl. F01D 15/10; F04D 25/06; H02K 7/18

(52) U.S. Cl. CPC F01D 15/10; F04D 25/06; F05D 2260/211; F05D 2220/62; F05D 2220/76; H02K 7/1823

(57) ABSTRACT

Systems and methods for generating electricity in an efficient manner using a recovery gas flow are provided. The electric generation system may comprise recovery turbine coupled to an electric generation assembly, wherein a rotor assembly is rotatably coupled to a rotating stator assembly for generating electricity. The electric generation assembly may include a heat recovery generator, wherein the heat from the generation of electricity is transferred to a flow of gas to produce a recovery gas flow. During operation, this recovery gas flow can be used as a prime mover to rotate the rotor and conserve energy. Particularly, the system may include a compressor coupled to receive and compress the recovery gas flow, such that the recovery gas flow may supply energy to the recovery turbine. Further, an expansion cooler may cool the recovery gas flow to providing the initial gas flow that circulates through out the system.

### BACKGROUND

In this age of explosive information and data, various companies look to the conservation of fuel and electricity to generate more economic value within electric and mechanical systems. Nearly all of the power in our nation's electric power grids is supplied by electric generators. These conventional electric generators are devices that convert mechanical energy into electrical power for use in an external circuit. Several sources of mechanical energy may be used to generate electric current, including but not limited to steam turbines, gas turbines, water turbines, internal combustion engines, hand cranks and the like. These generators may be used in nuclear power plants to produce electricity, wherein heat from a nuclear reactor is used to drive a steam turbine that is coupled to the electric generator.

Since its inception, the electromagnetic design for the electric generator typically comprises a stationary component (stator) and a rotating component (rotor). The rotor is rotatably coupled to the stator, wherein the rotor rotates around a center axis. The stator may comprise a number of stator windings axially extending in freely exposed end windings. Particularly, in an effort to generate three-phase alternating-current (AC) power, a three-phase AC generator may use a rotor assembly having a magnetic field, which is rotated within a stator assembly having a three-phase winding, in accordance with the law of electromagnetic induction.

Conventional designs for electric generators, however, only employ one method of generating electricity, wherein there is a rotating magnetic field, which is surrounded by a cage of conductors that form a conductor assembly. The stationary component is typically always this conductor assembly. In particular, the rotor assembly comprises a set of fixed magnets having a magnetic field, which are affixed a to rotating shaft. These fixed magnets possess a naturally occurring magnetic strength and magnetic field, which do not change. In some embodiments, when the magnetic field of the rotor cuts through the conductor assembly, electric current is generated. In other designs, the stator includes an electro-magnet having an adjustable voltage. In both designs, however, the process for generating electricity is inefficient. Particularly, during the production of electricity within an electrical generator, heat is generated by an armature of the rotor assembly. Current designs for electrical generators remove this heat to an unrecoverable medium. For example, some conventional generators use gas, coolants, or water-cooling elements that remove heat from the stator and rotor assembly. This removal of heat, however, represents a wasted resource of energy.

Further, typical electrical transmission of electricity to or from rotating components of the rotor assembly, such as exciter voltage to an armature, or output transmission of motor generators, is by way of carbon brushes and slip rings. Yet, the greater the number of components that exist within the process for electrical transmission increases the chances for a greater loss of energy that can exist within the system.

It is within this context that the embodiments arise.

### SUMMARY

Embodiments of systems and methods for generating electricity in an efficient manner using a recovery gas flow are provided. It should be appreciated that the present embodiment can be implemented in numerous ways, such as a process, an apparatus, a system, a device, or a method. Several inventive embodiments are described below.

In some embodiments, systems and methods for generating electricity in an efficient manner using a recovery gas flow are provided. The electric generation system may comprise recovery turbine coupled to an electric generation assembly, wherein a rotor assembly is rotatably coupled to a rotating stator assembly for generating electricity. The electric generation assembly may include a heat recovery generator, wherein the heat from the generation of electricity is transferred to a flow of gas to produce a recovery gas flow. During operation, this recovery gas flow can be used as a prime mover to rotate the rotor and conserve energy. Particularly, the system may include a compressor coupled to receive and compress the recovery gas flow, such that the recovery gas flow may supply energy to the recovery turbine. Further, an expansion cooler may cool the recovery gas flow to providing the initial gas flow that circulates through out the system.

In some embodiments, a method for generating electricity in an efficient manner using a recovery gas flow is provided. The method may include providing torque to a rotor assembly by a turbine and rotating a shaft of the rotor assembly for rotation within a stator assembly. The method may also include rotating the stator assembly as an energy conservation measure. Further, the method may include simultaneously supplying a gas flow to a gas entry assembly having a first cavity. In another step, the gas flow can be received by an electrical generator assembly having a second cavity associated with the rotor assembly and a third cavity associated with the stator assembly. In operation, the method further includes the propagation of the gas flow to extract heat from the rotor and stator assemblies, wherein the heat generated by the rotor assembly and the stator assembly can be transferred to the gas flow producing a recovery gas flow. In addition, the method may include receiving the recovery gas flow into a gas exit assembly having a fourth cavity for transferring the recovery gas flow to a compressor. Consequently, the method may include compressing the recovery gas flow and regulating the pressure of the recovery gas flow to a desired value. The compressed recovery gas flow may be delivered to the turbine as a source of energy. Optionally, the recovery gas flow may be cooled using an expansion cooler to be used as the gas flow, which is supplied the gas entry assembly.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one so skilled in the art without departing from the spirit and scope of the described embodiments.

FIG. 1 is a first system diagram of an electric generation system with recovery gas flow efficiency, in accordance with some embodiments.

FIG. 2 is an electrical circuit representation associated with the system diagram of the electric generation system of FIG. 1 in accordance with some embodiments.

FIG. 3 is a second system diagram of an electric generation system with recovery gas flow efficiency, in accordance with some embodiments.

FIG. 4 is a block diagram of an expansion cooling device of FIG. 1 that can be used to cool the recovery gas flow, in accordance with some embodiments.

FIG. 5 is a flow diagram of a method for generating electricity in an efficient manner using recovery gas flow in accordance with some embodiments.

### DETAILED DESCRIPTION

The following embodiments describe a system and method for generating electricity in an efficient manner using recovery gas flow. It can be appreciated by one skilled in the art, that the embodiments may be practiced without some or all of these specific details. In other instances, well known process operations have not been described in detail in order not to unnecessarily obscure the embodiments.

The systems and methods for generating electricity in an efficient manner using a recovery gas flow are provided. The electric generation system may comprise recovery turbine coupled to an electric generation assembly, wherein a rotor assembly is rotatably coupled to a rotating stator assembly for generating electricity. The electric generation assembly may include a heat recovery generator, wherein the heat from the generation of electricity is transferred to a flow of gas to produce a recovery gas flow. During operation, this recovery gas flow can be used as a prime mover to rotate the rotor and conserve energy. Particularly, the system may include a compressor coupled to receive and compress the recovery gas flow, such that the recovery gas flow may supply energy to the recovery turbine. Further, an expansion cooler may cool the recovery gas flow to providing the initial gas flow that circulates through out the system.

The system and method for generating electricity having the electric generation assembly is designed to recover the inefficiencies of current electric generators and those of the past. As known to those skilled in the art, electricity requires a specific speed of rotation of the armature to produce a specific frequency and voltage. When there are two rotating components rotating opposite each other that speed is reduced. Hence, the fuel required to produce that speed will also reduce. Thereby, the novel design of the electric generation assembly disclosed herein conserves energy in two ways. First, it requires a smaller amount of fuel to run than conventional electric generators. Second, the electric generation assembly uses the heat that is generated during the process of electricity generation to provide energy to other parts of a system. In particular, the recovery gas flow may be used to produce rotation of the rotor. More particularly, the electrical generator assembly described herein can recover the heat generated by the rotor and stator, compress this recovery gas flow, and return this gas flow to drive the rotating armature. In the alternative, the recovery gas flow may be used to produce rotation of the stator in lieu of a prime mover. Thereby, this electric generation assembly can recover wasted energy and put it back into the process and other areas of a system.

Further, the system and method for generating electricity having the novel electric generation assembly described herein may incorporate the use of a plurality of transmission rings coupled to the rotating stator and the rotor as opposed to commutators, carbon brushes, and slip rings. This supports a more efficient design. One set of rings may rotate with the shaft coupled to the armature providing DC input to produce an electromagnetic field on the armature. Another set of rings may rotate with the conductor assembly providing electrical output, wherein each ring is in contact with the associated phase of the AC current and electrically insulated from the other phases. For each of the sets of rotating rings, a set of stationary rings may indirectly couple with the rotating rings, wherein electricity can be transferred between the rotating and stationary rings by way of an electrically conductive fluid or similar medium. These stationary rings can be either connected to an output bus (associated with the conductor assembly) or an exciter voltage supply (associated with the rotor assembly).

Advantageously, instead of wasting the heat generated by the production of electricity as in conventional designs, the novel design for the electric generation assembly described herein uses a flow of gas within the electric generation assembly that recovers this heat and uses it for other purposes of power supply within the system.

The novel design of the system and method for generating electricity having the electric generation assembly described herein may be used in a great variety of applications. Regarding aviation, the electric generation assembly described herein can be used in place of conventional electrical generators to produce more electricity within an auxiliary propulsion power unit, which utilizes drag to create electricity. In the automotive industry, alternators may be redesigned using the novel features of the electrical generator described herein to produce more electricity. Hybrid vehicles may incorporate the features of the novel design for the electrical generator assembly described herein to produce more electricity for use as momentum captured while coasting in a regenerative breaking mode of operation. Any device that has a prime mover, which generates electricity, can use the electric generation assembly described herein. Although most methods for efficient design of an electrical generator focus upon the fuel consumption and consuming fuel, this generator conserves energy independent of its attached prime mover. This electric generation assembly and system thereof could enable nuclear power plants to produce more, economically feasible electricity on their own without the undue expense associated with fuel. The novel design of the electric generation assembly described herein may also enable providers that supply power for the local electrical power grid to supply more power on the grid at a greater economical value.

In the following description, numerous details are set forth. It will be apparent, however, to one skilled in the art, that the present embodiments may be practiced without these specific details. In some instances, well-known structures and devices are shown in block diagram form, rather than in detail, in order to avoid obscuring the inventive concepts disclosed.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment. Like reference numbers signify like elements throughout the description of the figures.

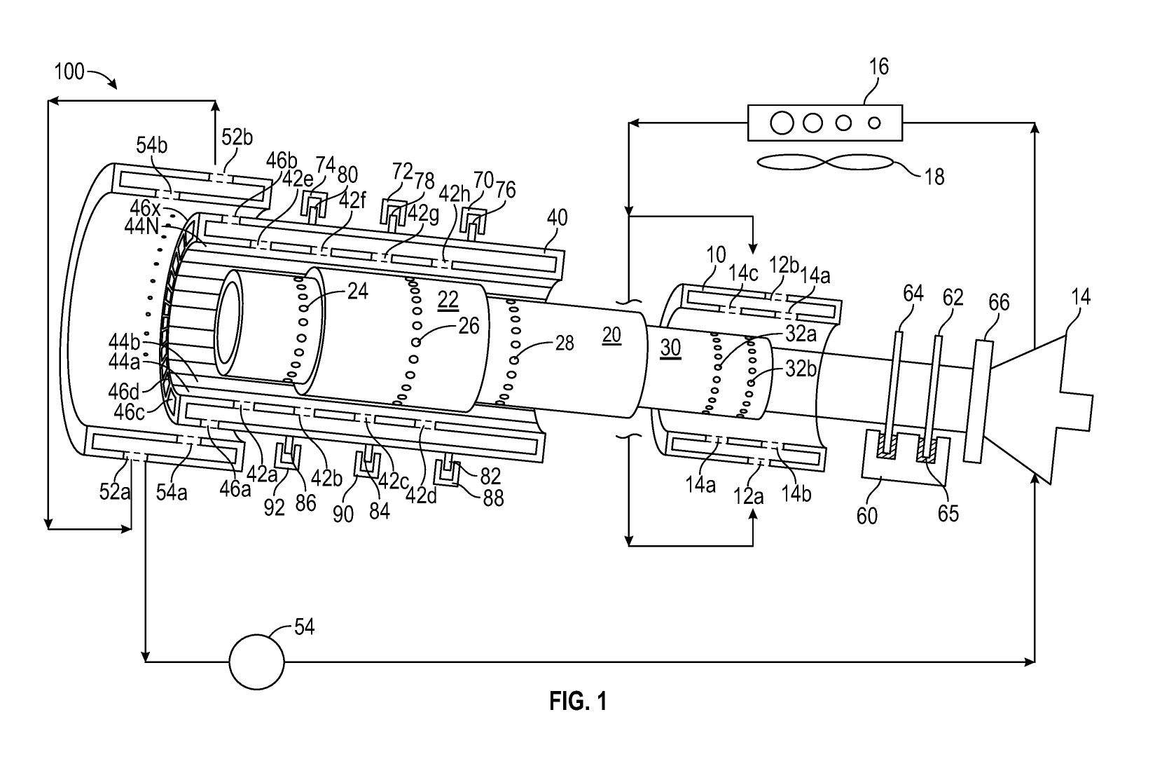

Referring to FIG. 1, a first system diagram of an electric generation system 100 with recovery gas flow efficiency, in accordance with some embodiments is shown. The system 100 may include an electric generation assembly (20, 30, 40), a heat generation assembly (10, 50), a compressor 54, a recovery turbine 14, and an expansion-cooling device 16. The system may further include a motorized fan 18 for further cooling of the recovery gas. In some embodiments, the heat generation assembly may include a gas entry assembly 10 and a gas exit assembly 50, wherein the gas entry assembly 10 surrounds to a shaft 20 of the rotor assembly and the gas exit assembly 50 surrounds the stator assembly 40. As shown, the recovery turbine 14 may coupled to receive a gas flow that enables it to convert the energy delivered into a motive force. For example, the recovery turbine 14 may couple to shaft 20 of a rotor assembly (20, 30). As such, the recovery turbine 14 can provide the torque necessary for rotation of shaft 20.The gas entry assembly may couple to the rotor assembly to provide a gas flow into a first cavity of the rotor assembly (20,30). The rotor assembly (20, 30) may rotatably couple to a rotating stator assembly 40. The gas flow may circulate through the rotor assembly (20,30) and the stator assembly 40 to be received by the gas exit assembly 50. Heat transfer from the heat generated by the armature 30 and stator 40 of the electric generation assembly (20, 30, 40) can produce a recovery gas, which may propagate through the gas exit assembly 50 to the compressor 54 to be compressed. In some embodiments, the compressor 54 may couple between the gas exit assembly 50 and the recovery turbine 14. The recovery gas may be used as a type of fuel for the recovery turbine 14, which also couples to the expansion cooler for cooling the recovery gas flow. Cooling of the recovery gas flow may be enhanced by positioning a DC motorized fan 18 adjacent to the expansion cooler 16 for additional forced cooling. The expansion cooler 16 may couple to the gas entry assembly 10 to feedback the supply of gas flow to the system 100.

The system 100 may further include a plurality of transmission rings (80-86, 78-84, and 76-82) coupled to the stator assembly 40 and a plurality of transmission rings (62, 64) coupled to the shaft 30 of the rotor assembly 20. Since the stator assembly 40 and the rotor assembly 20 rotate, these transmission rings rotate within stationary pairs of transmission ends (70, 72, 74, 82, 84, and 86). As such, rotating transmission rings (80-86, 78-84, and 76-82) serve as electrical output, wherein the stator assembly 40 produces electricity for the electric generator assembly (20, 30, 40). As shown, in some embodiments, a three-phase AC generator may use a rotor assembly having a magnetic field, which is rotated within a stator assembly having a three-phase winding. The stator assembly 40 may rotate using a prime mover.

In some embodiments, the gas entry assembly 10 and gas exit assembly 50 can be comprised of stationary housing for the circulation of gas flow through the electric generation assembly (20, 30, 40). As shown, the entry assembly 10 may include at least one gas inlet port 12(a, b) and a plurality of gas exit ports (14a, 14b, 14c, and 14d). Although four gas exit ports are shown, there may be any number of a plurality of gas exit ports (1-P) in the electric generation assembly disclosed herein. The cylindrical shaft 30 may couple to the cylindrical rotor assembly 20 including an armature 22. A plurality gas inlet ports (24, 28) are included in the rotor assembly 20 at its ends. Further, a plurality of gas inlet ports 26 may be included in the armature 22. The rotor assembly 20 is rotatably coupled to a stator or conductor assembly 40, wherein the rotor assembly 20 rotates counter to the rotation of the conductor assembly 40. The conductor assembly 40 includes a plurality of conductor elements 44a-44N. In particular, there can be any number of conductor elements 44 in the electric generation assembly (20, 30, 40) disclosed herein. The number of conductor elements 44 depends upon the design of the stator assembly 40. Each of the conductor elements 44 may include gas inlet ports 42(a-h) and gas exit ports 46(a-X). The gas exit assembly 50 may couple to receive the gas flow from the gas exit ports 46(a-X). In particular, the gas exit assembly 50 may include a gas inlet port 54(a, b) and a gas outlet port 52 located within the exterior and interior surfaces of the gas exit assembly 50. Although the conductor assembly 40, the rotor assembly 20 and a heat recovery generator assembly (10 and 50) are shown to have a cylindrical shape, the shape either of these assemblies can be configured in a great variety of geometric patterns, including but not limited to spherical, triangular, hexagonal, rectangular, and the like. Further, the dimension and size of the stator assembly 40, the rotor assembly 20 and a heat recovery generator assembly (10 and 50) may be in accordance with the size of each component in relation to one another. As shown, the entry assembly 10 can be smaller in circumference than the exit assembly 50 to accommodate for the size of the shaft 30 and the stator assembly 40, respectively. The components of the electric generation assembly 100 may be made of a great variety of materials. In particular, the conductor assembly 40, the rotor assembly 20 and a heat recovery generator assembly (10 and 50) may be made of various metals, plastics, glass, or any combination thereof. For example, the stator assembly 40, the rotor assembly 20 and a heat recovery generator assembly (10 and 50) may be made of steel, aluminum, or tungsten.

The transmission rings (80-86, 78-84, and 76-82) rotate with the corresponding coupled conductor elements 44 of the stator assembly 40. In a symmetric three-phase power supply system, three conductor elements 44 each carry an alternating current of the same frequency and voltage amplitude relative to a common reference, yet with a phase difference of one third the period. The common reference is usually connected to ground and often to a current-carrying conductor called the neutral. Due to the phase difference, the voltage on any conductor element 44 reaches its peak at one third of a cycle after one of the first phase associated other the conductor elements and one third of a cycle before the third phase conductor. This phase delay gives constant power transfer to a balanced linear load. It also makes it possible to produce the rotating magnetic field in the electric generator assembly (20, 30, 40). Each transmission ring (80-86, 78-84, and 76-82) is only in contact with the associated phase of the conductor and is electrically insulated from the other phases. Further, three stationary pairs of transmission ends (70, 72, 74, 82, 84, and 86) may indirectly couple to transmission rings (80-86, 78-84, and 76-82) through a conductive medium. For example, the gap between the stationary and rotating discs may include an electrically conductive fluid (such as, conductive grease) having highly conductive metal particles that stand up to high temperatures and high pressure, such as aluminum, silver, gold, copper, and the like.

Additionally, transmission rings, 62 and 64, may couple around the shaft 20, which that couples to the armature (not shown) rotatably coupled inside of the stator assembly 40. A dual input stationary transmission ring portion 60 may indirectly couple to transmission rings (62 and 64) through a conductive medium 65. For example, the gap between the stationary transmission ring portion 60 and rotating transmission rings, 62 and 64, may include an electrically conductive fluid (or conductive grease) having highly conductive metal particles that stand up to high temperatures and high pressure, such as aluminum, silver, gold, copper, and the like. Accordingly, the dual input stationary transmission ring portion 60 coupled to the rotating transmission rings (62 and 64) can serve as electrical input to the electric generation assembly (20, 30, 40), wherein AC or DC input can be used as input to produce an electromagnetic field on the armature 30 coupled to the shaft 20.

The system may further include an anti-rotation device 66 that couples around shaft 20 to inhibit the motion of the rotor assembly for rotation in one direction only. As the magnetic field cuts the conductor assembly 40, opposing electromagnetic forces are created. In conventional designs having one stationary component, this counter force requires more force and fuel to overcome. However, with the novel design of the electric generation system disclosed herein, the two rotating components (30 and 40) may tend to drive each other due to the counter electromotive force acting upon the magnetic field. In some cases, one component may have a stronger counter motive electric force, wherein it will drive the other one with the magnetic drive. In an effort to prevent the rotor assembly and the stator assemblies from being rotated in synchronization with one another, the anti-rotation device 66 prevents the rotor assembly from rotating in both directions.

In operation, the recovery gas can be used to remove heat generated during generation of electric current; and, drive the recovery turbine 14. As noted above, in one application, the recovery gas can be transferred to the rotating components (rotor assembly 20 and stator assembly 40) by way of the two stationary housing that exist at the entry and exit (10, 50), which cover the outboard ports of the rotating components. The recovery gas can begin at a cold temperature, entering the outboard inlet port (12a and 12b) of the armature shaft 20. Gas thereby can be routed through the shaft 20 in such a way as to remove heat from the electro-magnet of the armature 30 and the supporting components that generate the magnetic field. Additionally, the cold recovery gas can also be routed to cool the transmission rings (80-86, 78-84, and 76-82), prior to rejoining the gas stream at the suction of the compressor 54. The gas flow can then exit the shaft 20 from the center, and flow into the bottom ports of the rotating conductor elements 44 (of stator 40). Accordingly, the gas can be routed in such a way as to remove the heat of generation from the conductor elements 44. In some embodiments, the hot recovery gas can exit the conductor elements 44, and flow into the gas compressor 54, which adds additional heat of compression, supplying energy for the recovery turbine 14. In particular, compressor 54 can provide motive force for movement of the gas throughout the system 100. This motive force, in some embodiments may be assisted by the pressure drop in the expansion cooler 16, which cools the compressed gas flow. The recovery turbine 14 can use the recovered heat to rotate the armature assembly 30, wherein the exhaust of the turbine 14 can feed into expansion cooler 16, which raises the efficiency of the turbine 14. The expansion cooler 16 inlet pipe diameter can expand as the heated recovery gas travels through it. As the diameter expands, the pressure of the gas is reduced, thereby also reducing the temperature of the gas. In some embodiments, additional forced cooling can be added to the expansion cooler 16, through the use of the DC motorized fan 18. Accordingly, the cooled gas flow may be used to support the flow of gas necessary for recovery of the heat generated during the generation of electricity by electric generation assembly (20, 30, 40).

In operation, the transmission rings (62, 64, 80-86, 78-84, and 76-82) simplify the electric generation assemblies' ability to transmit electricity. These transmission rings make the electric generation assembly (20, 30, 40) more efficient. Conventional electric generators include commutators, carbon brushes, slip rings, and the like. These excessive components account for more electrical losses within a system. Particularly, every time electricity is transferred from one component to the next, heat loss exists. With the transmission rings, there is only one transfer. As a result, the design of the electric generation assembly and the system incorporating the same is more efficient and simplistic than the conventional electric generator. Further, maintenance for the electric generation assembly is significantly reduced. Common parts, such as the carbon brushes wear down frequently and need to be replaced often. However, the transmission rings (62, 64, 80-86, 78-84, and 76-82) do not need to be replaced when the electrically conductive fluid degrades and the conductive fluid can be changed easily, which ordinary does not happen for a long period of time.

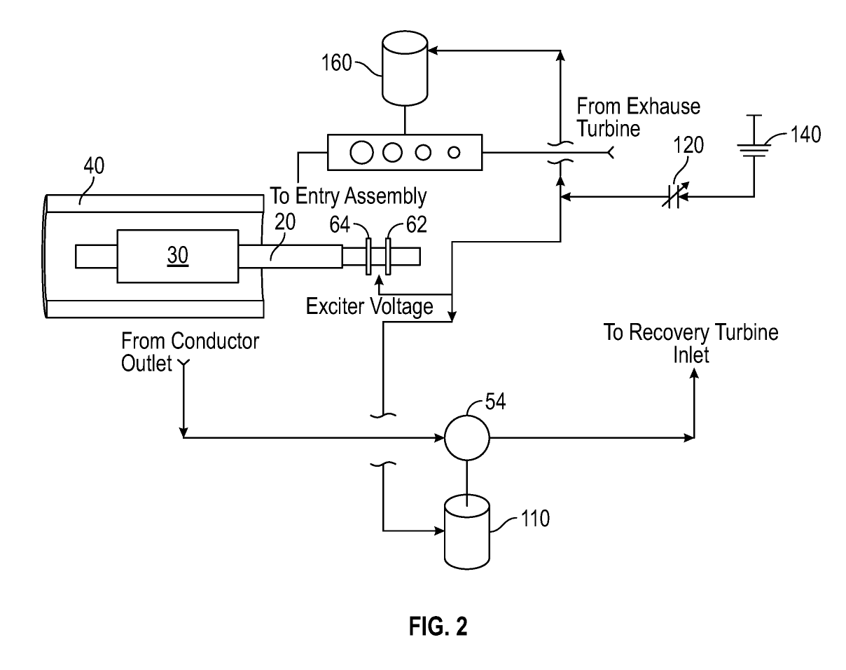

Referring to FIG. 2, an electrical circuit representation associated with the system diagram of the electric generation system of FIG. 1 in accordance with some embodiments is illustrated. The electrical circuit includes an exciter voltage supply 140, a voltage regulator 120, a first DC motor 110 and a variable speed DC motor 160. As shown, in some embodiments the exciter voltage supply 140 may couple to a voltage regulator 120 to provide an exciter voltage at the dual input stationary transmission ring portion 60, which indirectly couples to transmission rings (62 and 64). This exciter voltage may also couple to the DC motor 110, which couples to provide power for compressor 54. Further, the exciter voltage may couple to the variable speed DC motor 160, which provides power for the DC motorized fan 18.

In operation, when a DC voltage is applied to the armature 30, the strength of the magnetic field is controlled, which in turn controls the electric generation assembly (20, 30, 40) output. The magnetic field is relative to the volume of power, and in turn it changes the overall output of the generator. Given the inventive concept of the electric generation system described herein, the DC power going to the armature 30 runs through the voltage regulator 120. As the power is raised, more heat will be generated from the electric generation assembly (20, 30, 40), which will require more pressure from the compressor 54 and more cooling of the exhaust from the recovery turbine 14. In response, as power to the armature 30 increases to raise the output power, the novel design enables the increase of power going to the variable speed input DC motor 160. The voltage regulator 120 sends the DC current as an exciter voltage, wherein this voltage increases the power to the armature 30, increases the power to the cooling motor 160, and increases the power to the compressor motor. At the same time that the generator output increases, this novel design increases the electric generation systems' ability to cool and operate the recovery turbine 14. There is no additional response needed. Unlike conventional systems that require a sequential increase in power to the turbine, followed by the compressor and then the cooling device mechanism, this novel design provides for simultaneous increase in power in all of these mechanisms. The increased power happens all at once, wherein the increase is proportional to the load put upon the electric generation assembly (20, 30, 40). As the voltage regulator 120 changes to raise the strength of the armature 30, the voltage regulator 120 is also raising the power supplied to the motors (160 and 110) driving the fan and driving the compressor, respectively. Accordingly, as the electric generation demand increases, the voltage regulator 120 raises the excitor voltage, along with increasing the voltage for supplying the cooling feature and the compressor speed.

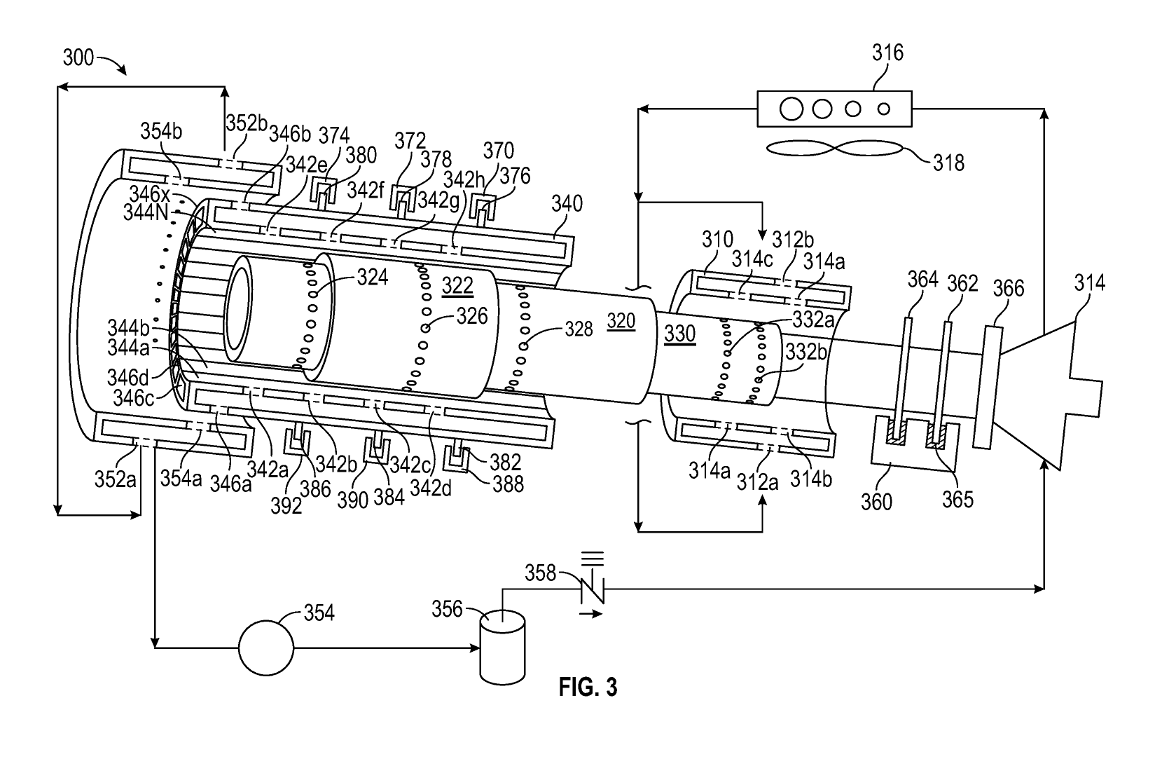

Referring to FIG. 3, a second system diagram of an electric generation system with recovery gas flow efficiency, in accordance with some embodiments is provided. In some embodiments, the electric generation system 300 may include an electric generation assembly (320, 330, 340), a heat generation assembly (310, 350), a compressor 354, a high pressure gas storage 356, a spring loaded check value 358, a recovery turbine 314, and an expansion-cooling device 316. The system may further include a motorized fan 318 for further cooling of the recovery gas. Similar to the electric generation system 100 of FIG. 1, the heat generation assembly may include a gas entry assembly 310 and a gas exit assembly 350, wherein the gas entry assembly 310 surrounds to a shaft 320 of the rotor assembly and the gas exit assembly 350 surrounds the stator assembly 340. As shown, the recovery turbine 314 may coupled to receive a gas flow that enables it to convert the energy delivered into a motive force. For example, the recovery turbine 314 may couple to shaft 320 of a rotor assembly (320, 330). As such, the recovery turbine 314 can provide the torque necessary for rotation of shaft 320.The gas entry assembly may couple to the rotor assembly to provide a gas flow into a first cavity of the rotor assembly (320, 330). The rotor assembly (320, 330) may rotatably couple to a rotating stator assembly 340. The gas flow may circulate through the rotor assembly (320, 330) and the stator assembly 340 to be received by the gas exit assembly 350. Heat transfer from the heat generated by the armature 330 and stator 340 of the electric generation assembly (320, 330, 340) can produce a recovery gas, which may propagate through the gas exit assembly 350 to the compressor 354 to be compressed. In some embodiments, the compressor 354 may couple between the high-pressure gas storage 356 and the gas exit assembly 350, wherein the compressor 354 raises the pressure for the high-pressure gas storage 356. High-pressure gas storage 356 can act as a surge volume for the compressed gas, which enables continuous operation of the turbine 314 during system transients. In some embodiments, the suction of the compressor 354 can be the point where a make-up supply of recovery gas can enter into the system 300 when needed. The spring-loaded check valve 358 may couple to the high pressure gas storage 356 to prevent any gas from going into the turbine 314 until there is a large enough reserve at a high enough pressure to maintain the operation of the turbine 314. In operation, the spring loaded check valve 358 will not open until the high-pressure storage 356 is higher than the minimum pressure required for turbine operation. For example, the spring-loaded check valve 358 can be set such that until the storage tank reaches 150% of the required pressure, no gas flow will reach the turbine 314. This insures that there is always going to be additional volume for a transient. Thereby, the recovery gas flow serves as a switch and not as the primary source of pressure, wherein the recovery gas flow raises the pressure of the high-pressure gas storage 356. Similar to the system of FIG. 1, cooling of the recovery gas flow may be enhanced by positioning a DC motorized fan 318 adjacent to the expansion cooler 316 for additional forced cooling. The expansion cooler 316 may couple to the gas entry assembly 310 to feedback the supply of gas flow to the system 300.

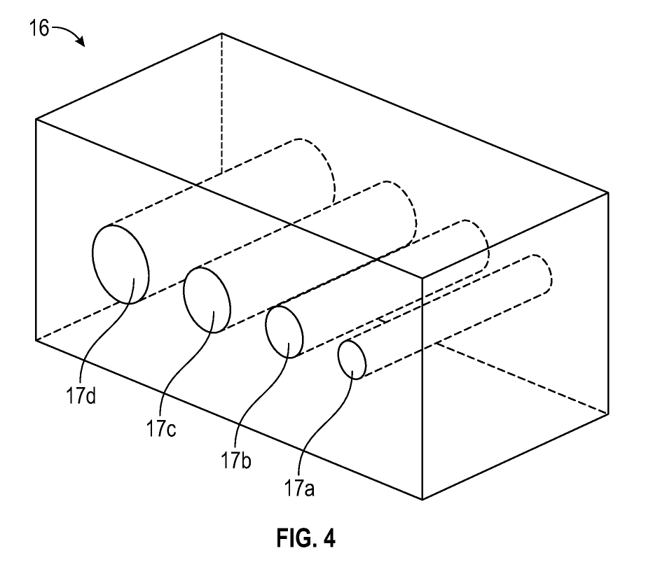

Referring to FIG. 4, a block diagram of an expansion-cooling device of FIG. 1 that can be used to cool the recovery gas flow, in accordance with some embodiments is shown. The expansion cooling device 16 may include a plurality of expansion pipes (17a-d), having different diameters. The expansion cooling device 16 couples to the recovery turbine 14 to receive the exhaust from the recovery turbine 14. The exhaust comprises the compressed gas sent from compressor 54. As the compressed gas goes through each pipe (17a-d), the diameter increases within the pipe. The increase in diameter causes the pressure of the gas flow to decrease, which decreases the temperature of the same. As an additional feature, forced cooling may be implemented using the DC motorized fan 18 to further reduce pressure by reducing the temperature of the gas flow. Reducing the pressure at the exhaust of the turbine 14 increases the differential pressure across the turbine, allowing for more work to be done by the turbine without consuming more fuel.

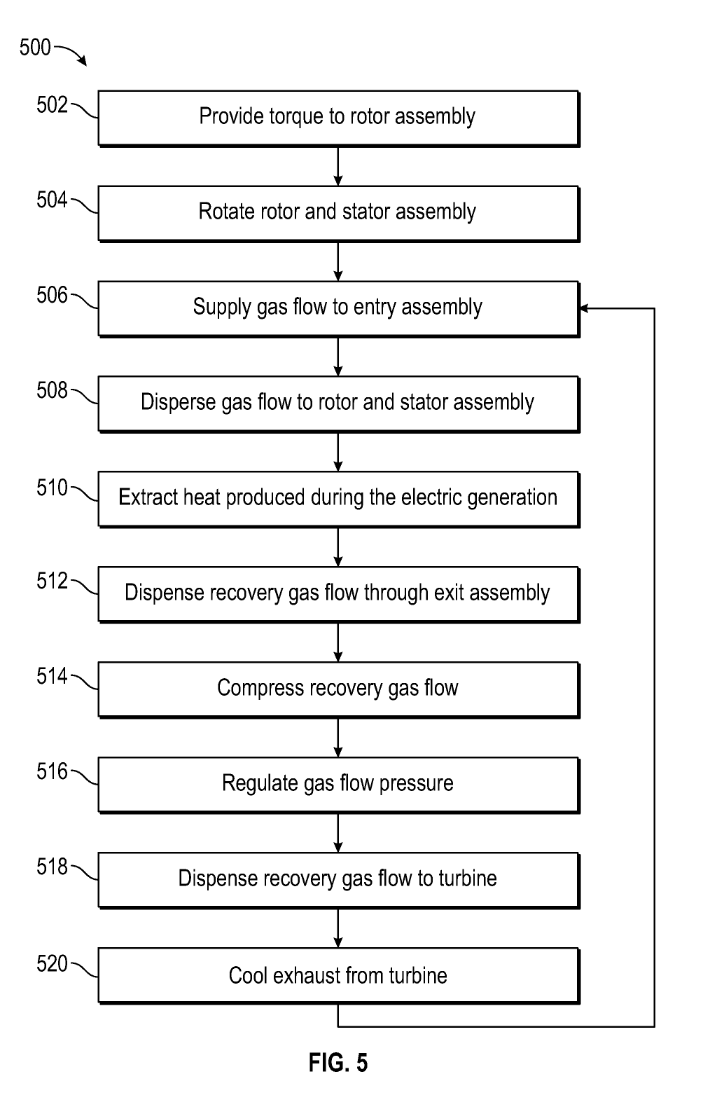

Referring to FIG. 5, a flow diagram of a method for generating electricity in an efficient manner using recovery gas flow in accordance with some embodiments is illustrated. In an action 502, the method may include providing torque to a rotor assembly. For example, a turbine can be coupled to the shaft and may exert a rotational force upon the shaft of the rotor assembly. Further, the method may include in an action 504 rotating the shaft of the rotor assembly for rotation within a stator assembly in one direction; and rotating the stator assembly in an opposite direction to that of the rotor assembly. Another component of the system may supply a cool gas flow to an entry assembly having a first cavity, in an action 506. In an action 508, the method may include dispersing the gas flow to the rotor and stator assembly in a second and third cavity, respectively. For example, the gas entry assembly, the rotor assembly, and stator assembly may include a cavity system that supports gas flow. When the cool gas flow is pumped into the gas entry assembly, the gas flow flows through the cavity network with the rotor and stator assemblies. In an action 510, the method may include extracting heat from the rotor assembly and the stator assembly using the gas flow. For example, the associated cavity within the rotor assembly may be positioned in such a way as to enable heat transfer from an armature to the gas flow that occurs during electric current generation; and thereby, produce a recovery gas flow. Next, the method may include receiving the recovery gas flow into a gas exit assembly in an action 512. Further, in an action 514, the method may include compressing the recovery gas flow. The method may also include regulating the pressure of the recovery gas flow to a desired value in an action 516. Next, the compressed gas flow may be delivered to the turbine that supplies the torque for driving the rotor assembly in an action 518. Further, the exhaust from the turbine may be cooled using an expansion cooler in an action 520. Finally, the cooled recovery gas flow may be supplied to the gas entry assembly as a cyclic recovery measure back to action 506 to preserve energy within the system.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “I” symbol includes any and all combinations of one or more of the associated listed items. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved. With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. An electric generation system comprising:
a recovery turbine;
an electric generation assembly coupled to the recovery turbine, wherein the electric generation assembly comprises:
a rotating stator rotated by a prime mover;
a rotor rotatably positioned within the rotating stator, wherein the rotation of the rotor is counter to the rotation of the rotating stator; and
a heat recovery generator, wherein the rotating stator and the rotor are seated within the heat recovery generator and the rotor is rotated using recovery gas flow from the recovery turbine that propagates through the heat recovery generator;
a compressor coupled to receive the recovery gas flow;
a high pressure storage tank couples to receive the compressed gas flow for surge volume control of the compressed gas, wherein the compressed gas raises the pressure of the high pressure storage tank; and
a spring loaded check valve coupled to an outlet of the high pressure storage tank to regulate the flow of compressed gas to the recovery turbine, wherein the spring loaded check valve opens when the high pressure storage tank is higher than the minimum pressure required for the recovery turbine operation.

2. The electric generation system of claim 1, wherein the heat recovery generator comprises:
a gas entry assembly, an exterior surface of the housing having at least one gas inlet port leading to a first inner cavity for recovery gas flow, and an interior surface of the housing having at least one gas outlet port;
a gas exit assembly having a cylindrical-shaped housing with a hollow core, an interior surface of the housing having at least one gas inlet port leading to a second inner cavity for recovery gas flow, and an exterior surface of the housing having at least one gas outlet port; and
wherein the rotating stator having a third inner cavity for recovery gas flow and the rotor having a fourth inner cavity for recovery gas flow, the rotating stator and the rotor comprise a plurality of gas inlet ports and a plurality of gas outlet ports through an exterior surface and an interior surface to support recovery gas flow within the third inner cavity and fourth inner cavity;
wherein, when recovery gas is pumped through the gas flow entry assembly, the recovery gas flow circulates through the first cavity, the second cavity, the third cavity, and the fourth cavity to exchange the heat generated by the electric generation assembly to other parts of an electrical system.

3. The electric generation system of claim 1, wherein the electric generation assembly further comprises:
a plurality of rotating transmission rings coupled to the rotating stator, wherein each rotating transmission ring couples to the conductor elements associated with one phase of three phases;
a plurality of rotating transmission rings coupled to the rotor;
a plurality of stationary transmission rings positioned adjacent to the plurality of rotating transmission rings coupled to the rotating stator and the rotor; and
a conductive grease applied between the plurality of rotating transmission rings and the plurality of stationary transmission rings for transferring electricity between the rotating transmission rings to the stationary transmission rings.

4. The electric generation system of claim 1, wherein the rotating stator comprises,
a plurality of conductor elements having an interior wall and an exterior wall, the plurality of conductor elements coupled to one another to form a cylinder, the interior walls of each conductor element having a plurality of gas inlet ports, the exterior walls of each conductor element having a gas outlet port;
wherein, the plurality of conductor elements comprise a three phase winding circuit to produce a rotating magnetic field having three phases;
a first transmission ring directly coupled to the plurality of conductor elements associated with a first phase of an alternating current;
a second transmission ring directly coupled to the plurality of conductor elements associated with a second phase of an alternating current;
a third transmission ring directly coupled to the plurality of conductor elements associated with a third phase of an alternating current;
wherein, the rotating stator generates electrical current as the plurality of conductor elements rotate with respect to the rotor; the first transmission ring being electrically coupled to the plurality of conductor elements, the first of transmission ring providing a connection point for electrical current corresponding to the first phase to flow from the rotating stator, the second of transmission ring providing a connection point for electrical current corresponding to the second phase to flow from the rotating stator, the third of transmission ring providing a connection point for electrical current corresponding to the third phase to flow from the rotating stator.

5. The electric generation system of claim 1, wherein the rotor comprises,
a housing;
a shaft member having a first end and a second end, the shaft rotatably positioned within the housing to rotate with respect to the stator;
a pair of transmission rings directly coupled to the second end of the shaft;
an armature positioned coupled to the shaft member and extending towards the first end of the shaft, the armature for generating electrical current through an armature winding as the armature rotates with respect to the rotating stator; the pair of transmission rings being electrically coupled to the armature, the pair of transmission rings providing a connection point for electrical current to flow to and from the armature.

6. The electric generation system of claim 2, wherein the diameter of the gas entry assembly is smaller than the diameter of the gas exit assembly.

7. The electric generation system of claim 2, wherein the gas flow entry assembly comprises,
a cylindrical-shaped housing with a hollow core.

8. The electric generation system of claim 2, wherein the gas flow exit assembly comprises,
a cylindrical-shaped housing with a hollow core.

9. The electric generation system of claim 1, wherein the electric generation assembly further comprises:
an anti-rotation device coupled to the rotor for preventing the rotor from rotating in two directions.

10. A electric generation system comprising:
a recovery turbine;
an electric generation assembly coupled to the recovery turbine, wherein the electric generation assembly comprises:
a rotating stator rotated by a prime mover;
a rotor rotatably positioned within the rotating stator, wherein the rotation of the rotor is counter to the rotation of the rotating stator; and
a heat recovery generator, wherein the rotating stator and the rotor are seated within the heat recovery generator and the rotor is rotated using recovery gas flow from the recovery turbine that propagates through the heat recovery generator;
a compressor coupled to receive the recovery gas flow and generate compressed gas; and
a pressure regulator coupled to receive the compressed gas for reducing pressure of the compressed gas to a desired value;
wherein the regulated gas is delivered to the recovery turbine to extract energy from the regulated gas and convert it into torque necessary to rotate the rotor.

11. The electric generation system of claim 10, wherein the heat recovery generator comprises:
a gas entry assembly, an exterior surface of the housing having at least one gas inlet port leading to a first inner cavity for recovery gas flow, and an interior surface of the housing having at least one gas outlet port;
a gas exit assembly having a cylindrical-shaped housing with a hollow core, an interior surface of the housing having at least one gas inlet port leading to a second inner cavity for recovery gas flow, and an exterior surface of the housing having at least one gas outlet port; and
wherein the rotating stator having a third inner cavity for recovery gas flow and the rotor having a fourth inner cavity for recovery gas flow, the rotating stator and the rotor comprise a plurality of gas inlet ports and a plurality of gas outlet ports through an exterior surface and an interior surface to support recovery gas flow within the third inner cavity and fourth inner cavity;
wherein, when recovery gas is pumped through the gas flow entry assembly, the recovery gas flow circulates through the first cavity, the second cavity, the third cavity, and the fourth cavity to exchange the heat generated by the electric generation assembly to other parts of an electrical system.

12. The electric generation system of claim 10, wherein the electric generation assembly further comprises:
a plurality of rotating transmission rings coupled to the rotating stator, wherein each rotating transmission ring couples to the conductor elements associated with one phase of three phases;
a plurality of rotating transmission rings coupled to the rotor;
a plurality of stationary transmission rings positioned adjacent to the plurality of rotating transmission rings coupled to the rotating stator and the rotor; and
a conductive grease applied between the plurality of rotating transmission rings and the plurality of stationary transmission rings for transferring electricity between the rotating transmission rings to the stationary transmission rings.

13. The electric generation system of claim 10, wherein the rotating stator comprises,
a plurality of conductor elements having an interior wall and an exterior wall, the plurality of conductor elements coupled to one another to form a cylinder, the interior walls of each conductor element having a plurality of gas inlet ports, the exterior walls of each conductor element having a gas outlet port;
wherein, the plurality of conductor elements comprise a three phase winding circuit to produce a rotating magnetic field having three phases;
a first transmission ring directly coupled to the plurality of conductor elements associated with a first phase of an alternating current;
a second transmission ring directly coupled to the plurality of conductor elements associated with a second phase of an alternating current;
a third transmission ring directly coupled to the plurality of conductor elements associated with a third phase of an alternating current;
wherein, the rotating stator generates electrical current as the plurality of conductor elements rotate with respect to the rotor; the first transmission ring being electrically coupled to the plurality of conductor elements, the first of transmission ring providing a connection point for electrical current corresponding to the first phase to flow from the rotating stator, the second of transmission ring providing a connection point for electrical current corresponding to the second phase to flow from the rotating stator, the third of transmission ring providing a connection point for electrical current corresponding to the third phase to flow from the rotating stator.

14. The electric generation system of claim 10, wherein the rotor comprises,
a housing;
a shaft member having a first end and a second end, the shaft rotatably positioned within the housing to rotate with respect to the stator;
a pair of transmission rings directly coupled to the second end of the shaft;
an armature positioned coupled to the shaft member and extending towards the first end of the shaft, the armature for generating electrical current through an armature winding as the armature rotates with respect to the rotating stator; the pair of transmission rings being electrically coupled to the armature, the pair of transmission rings providing a connection point for electrical current to flow to and from the armature.

15. A method of generating electricity comprising:
providing torque to a rotor assembly by a turbine;
rotating a shaft of the rotor assembly for rotation within a stator assembly;
rotating the stator assembly;
supplying a gas flow to a gas entry assembly having a first cavity;
dispersing the gas flow to the rotor assembly into a second cavity of the rotor assembly from the gas entry assembly;
dispersing the gas flow within the stator assembly into a third cavity from the rotor assembly;
extracting heat from the rotor assembly and the stator assembly, wherein the heat generated by the rotor assembly and the stator assembly is transferred to the gas flow producing a recovery gas flow;
receiving the recovery gas flow into a gas exit assembly having a fourth cavity for transferring the recovery gas flow to compressor;
compressing the recovery gas flow;
regulating the pressure of the recovery gas flow to a desired value;
delivering the compressed recovery gas flow to the turbine;
cooling the recovery gas flow using an expansion cooler; and
delivering the cooled recovery gas flow to supply the gas flow to the gas entry assembly.

16. The method of claim 15, wherein the supplying a gas flow comprises:
cooling the recovery gas flow; and
pumping the cooled gas flow into the gas entry assembly.

17. The method of claim 15, wherein the receiving the gas flow by the rotor assembly comprises:
opening gas inlets within the exterior surface of the rotor assembly; and
pumping the gas flow through the second cavity of the rotor assembly.

18. The method of claim 15, wherein the rotating the electrical generator assembly comprises:
retrieving the recovery gas flow; and
powering the turbine with the recovery gas flow, such that a shaft of the rotor assembly coupled to the turbine is rotated.

19. The method of claim 15, further comprising:
inhibiting the rotation of the rotor assembly to rotation in one direction using an anti-rotation device, wherein the one direction of the rotor assembly opposes the rotation of the stator assembly.

20. The method of claim 15, further comprising:
applying forced cooling to the recovery gas flow using a DC motorized fan.
